(19) United States
(12) Patent Application Publication
(10) Pub. No.: US 2009/0161982 A1
(43) Pub. Date: Jun. 25, 2009

(54) Restoring images

(75) Inventors: Marius Tico, Tampere (FI); Markku Vehvilainen, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/004,469

(22) Filed: Dec. 19, 2007

(51) Int. Cl. G06K 9/40

(52) U.S. Cl. 382/275; 382/268

(57) ABSTRACT

The specification and drawings present a new method, apparatus and software product for restoring (i.e., de-noising and/or stabilizing) images using similar blocks of pixels of one or more different sizes in one or more available image frames of the same scene for providing, e.g., multi-frame image restoration/de-noising/stabilization.

### TECHNICAL FIELD

This invention generally relates to electronic imaging, and more specifically to restoring (e.g., de-noising and/or stabilizing) images using identification of similar blocks of pixels.

### BACKGROUND ART

The images provided by mobile cameras are often noisier than the images provided by high end SLR (single-lens reflex) cameras. This difference in quality is mainly caused by a strong miniaturization requirement imposed on mobile cameras. Thus, thinner and smaller mobile devices cannot be produced without smaller cameras, and ultimately without smaller imaging sensors. On the other hand the general trend for higher image resolutions combined with the sensor miniaturization results in a significant reduction of the light collecting area in each pixel. Because of that, the pixel size of a typical SLR camera sensor is about ten times larger than the pixel size of a mobile camera. A smaller pixel captures a smaller number of photons per second and hence it needs either more integration time or more light, in order to achieve similar performance of a larger pixel. Otherwise the signal generated by the small pixel can be heavily affected by noise and ultimately can result in noisy pictures.

Often the only solutions may be either to use some de-noising procedure of the captured image, or to extend the integration time in order to capture more photons. Using a larger exposure time could be problematic, especially for camera phones, because any motion during exposure may result in degradation of the image known as motion blur. The solutions for ensuring enough integration time without motion blur are collectively known as image stabilization solutions. The image stabilization solutions are primarily aiming to prevent or to remove the image degradation caused by the motion during the exposure time. Two categories of solutions can be distinguished: solutions based on a single image frame (e.g. optical image stabilizers), and solutions based on multiple image frames.

Single-frame solutions are based on capturing a single image frame during a long exposure time. This is actually the classical case of image capturing, where the acquired image is typically corrupted by motion blur, caused by the motion that have taken place during the exposure time. In order to restore the image it is necessary to have very accurate knowledge about the motion that took place during the exposure time. Consequently this approach might need quite expensive motion sensors (gyroscopes), which apart of their costs are also large in size and hence difficult to incorporate into small devices. In addition, if the exposure time is large, then the position information derived from the motion sensor output can exhibit a bias drift error with respect to the true value. This error can accumulate in time such that at some point it may affect significantly the outcome of the system.

A special case of single-frame solutions is implemented by several manufactures (e.g. CANON, PANASONIC, MINOLTA, etc), in high-end cameras. This approach consists of correcting for the motion by moving the optics (or the sensor) in order to keep the image projected into the same position on the sensor during the exposure time. However, this solution may not be practical for long exposure times due to a system drift error and inability to compensate any other motion except translation.

Multi-frame solutions are solutions based on dividing a long exposure time in several shorter intervals by capturing several image frames of the same scene. The exposure time for each frame can be small in order to reduce the motion blur degradation of the individual frames. After capturing all these frames the final image is calculated in two steps:
1. Registration step: registering all image frames with respect to one of them chosen as reference frame, and
2. Pixel fusion: calculating the value of each pixel in the final image based on its values in all individual frames. One simple method of pixel fusion could be to calculate the final value of each pixel as the average of its values in the individual frames.
   The following problems can be identified with multi-frame image fusion:
1. Errors in image registration: these errors could occur either because of the presence of outliers represented by moving objects, poor accuracy of the registration method used, or insufficiently complex motion model between the image frames;
2. Moving objects in the scene: if there are objects in the scene which are moving during the time the image frames are acquired, these objects are distorted in the final image, wherein the distortion may appear when pasting together multiple instances of the objects;
3. Low quality image frames: often some frames could be degraded by motion or out-of-focus blur that could affect the entire frame or only part of it, such that the degraded image regions may reduce the quality of the final image when the image frames are fused together.

Another image de-noising approach based on weighted averaging similar pixels in the image was proposed by A. Buades, B. Coll, J. Morel, in “Image denoising by non-local averaging”, International Conf. on Acoustic, Speech and Signal Processing 2005, Vol. 2, pp. 25-28. The similarity between pixels is calculated based on the non-local averaging of all pixels in the image (i.e., the final value of each pixel is calculated as the weighted averaging of all the pixels in the image)

### DISCLOSURE OF THE INVENTION

According to a first aspect of the invention, a method, comprises: identifying one or more similar blocks of a block in one or more image frames of a scene using a predetermined criterion, wherein the block comprises a plurality of pixels and is comprised in a reference image frame, the reference image frame being one of the one or more image frames; and restoring the block by combining, using a predetermined algorithm, pixel signals of the plurality of pixels comprised in the block with corresponding pixel signals of the one or more similar blocks identified for the block.

According further to the first aspect of the invention, the restoring may be implemented only if enough of the one or more similar blocks is found according to the predetermined criterion, and if there is not enough of the one or more similar blocks found, the method may further comprise: further dividing the block into smaller blocks each comprising one or more pixels; identifying one or more further similar blocks for each of the smaller blocks using the predetermined criterion or a further predetermined criterion; and restoring the smaller blocks using the predetermined algorithm or a further predetermined algorithm by combining, for each of the smaller blocks, pixel signals of the one or more pixels comprised in the each of the smaller blocks with corresponding pixel signals of the one or more further similar blocks identified for the each of the smaller blocks. Still further, the one or more similar blocks may be identified within a search area in the one or more image frames and the one or more further similar blocks may be identified within the search area or within a further search area in the one or more image frames.

Further according to the first aspect of the invention, before the identifying, the method may comprise: selecting the reference image frame of the scene out of the one or more image frames of the scene automatically or through a user interface.

Still further according to the first aspect of the invention, the method may further comprise: performing the identifying and the restoring using the predetermined criterion and the predetermined algorithm for each block beside the block of a plurality of blocks in the reference image frame.

According further to the first aspect of the invention, the identifying of the one or more similar blocks may be performed by comparing pixel signals of the plurality of pixels comprised in an outer block centered in and comprising the block with corresponding pixel signals of other outer blocks centered in and comprising corresponding other blocks of the one of more image frames within a search area using one or more threshold values.

According still further to the first aspect of the invention, the identifying and the restoring may be performed independently for one or more color components comprised in the one or more image frames. Still further, the one or more similar blocks for the block may be identified separately for one or more selected color components of the one or more color components and the restoring may be performed only for the one or more selected color components.

According further still to the first aspect of the invention, the identifying and the restoring may be performed in combination for all color components comprised in the one or more image frames, such that the one or more similar blocks for the block may be identified using the predetermined criterion for the all color components and the restoring of the block may be performed for each of the all color components only if the one or more similar blocks are found for all the color components in combination.

According yet further still to the first aspect of the invention, the identifying and the restoring may be performed by an electronic device which is a digital camera, a communication device, a wireless communication device, a portable electronic device, a mobile electronic device or a camera phone.

According to a second aspect of the invention, a computer program product comprises: a computer readable storage structure embodying a computer program code thereon for execution by a computer processor with the computer program code, wherein the computer program code comprises instructions for performing the first aspect of the invention.

According to a third aspect of the invention, an apparatus, comprises: a similar block selection module, configured to identify one or more similar blocks of a block in one or more image frames of a scene using a predetermined criterion, wherein the block comprises a plurality of pixels and is comprised in a reference image frame, the reference image frame being one of the one or more image frames; and a block restoration module, configured to restore the block by combining, using a predetermined algorithm, pixel signals of the plurality of pixels comprised in the block with corresponding pixel signals of the one or more similar blocks identified for the block.

According further to the third aspect of the invention, the similar block selection module may be configured to divide the block into smaller blocks each comprising one or more pixels, if not enough of the one or more similar blocks is found according to the predetermined criterion, to further identify one or more further similar blocks for each of the smaller blocks using the predetermined criterion or a further predetermined criterion, and the restoration module may be further configured to restore the smaller blocks using the predetermined algorithm or a further predetermined algorithm by combining for each of the smaller blocks pixel signals of the one or more pixels comprised in the each of the smaller blocks with corresponding pixel signals of the one or more further similar blocks identified for the each of the smaller blocks. Still further, the similar block selection module may be configured to identify the one or more similar blocks within a search area in the one or more image frames, and the similar block selection module may be configured to identify the one or more further similar blocks within the search area or within a further search area in the one or more image frames. Yet still further, one or more threshold conditions for identifying the one or more similar blocks of the block and for identifying the one or more further similar blocks of the smaller blocks may be the same or different.

Further according to the third aspect of the invention, the one or more image frames may be provided to the apparatus through a network communication. Still further, the network communication may be a network communication over Internet.

Still further according to the third aspect of the invention, the apparatus may further comprise: a reference frame selection module, configured to select the reference image frame of the scene out of the one or more image frames of the scene automatically or using a command provided through a user interface.

According further to the third aspect of the invention, the similar block selection module may be configured to identify the one or more similar blocks within a search area in the one or more image frames.

According still further to the third aspect of the invention, the similar block selection module may be configured to identify the one or more similar blocks by comparing pixel signals of the plurality of pixels comprised in the block with corresponding pixel signals of other blocks in the one or more images within a search area using one or more threshold values.

According yet further still to the third aspect of the invention, the similar block selection module may be configured to identify the one or more similar blocks by comparing pixel signals of the plurality of pixels comprised in an outer block centered in and comprising the block with corresponding pixel signals of other outer blocks centered in and comprising corresponding other blocks of the one of more image frames within a search area using one or more threshold values.

According further still to the third aspect of the invention, the similar block selection module may be configured to identify the one or more similar blocks and the block restoration module may be configured to restore the block independently for one or more color components comprised in the one or more image frames.

Yet still further according to the third aspect of the invention, the similar block selection module may be configured to identify the one or more similar blocks for the block separately for one or more selected color components of the one or more color components such that the block restoration module may be configured to restore the only for the one or more selected color components.

Still yet further according to the third aspect of the invention, the similar block selection module may be configured to identify the one or more similar blocks and the block restoration module may be configured to restore the block in combination for all color components comprised in the one or more image frames, such that the one or more similar blocks for the block may be identified using the predetermined criterion for the all color components and the restoring of the block may be performed for each of the all color components only if the one or more similar blocks are found for all the color components in combination.

According to a fourth aspect of the invention, an electronic device, comprises: image capturing module, for capturing one or more image frames; a similar block selection module, configured to identify one or more similar blocks of a block in one or more image frames of a scene using a predetermined criterion, wherein the block comprises a plurality of pixels and is comprised in a reference image frame, the reference image frame being one of the one or more image frames; and a block restoration module, configured to restore the block by combining, using a predetermined algorithm, pixel signals of the plurality of pixels comprised in the block with corresponding pixel signals of the one or more similar blocks identified for the block.

According further to the fourth aspect of the invention, the electronic device may further comprise: a memory for storing the one or more image frames.

According to a fifth aspect of the invention, an apparatus, comprises: means for identifying one or more similar blocks of a block in one or more image frames of a scene using a predetermined criterion, wherein the block comprises a plurality of pixels and is comprised in a reference image frame, the reference image frame being one of the one or more image frames; and means for restoring the block by combining, using a predetermined algorithm, pixel signals of the plurality of pixels comprised in the block with corresponding pixel signals of the one or more similar blocks identified for the block.

According further to the fifth aspect of the invention, the means for identifying may be configured to divide the block into smaller blocks each comprising one or more pixels if the one or more similar block are not found and to identify one or more further similar blocks for each of the smaller blocks using the predetermined criterion or a further predetermined criterion, and the means for restoring may be configured to restore the smaller blocks using the predetermined algorithm or a further predetermined algorithm by combining for each of the smaller blocks pixel signals of the one or more pixels comprised in the each of the smaller blocks with corresponding pixel signals of the one or more further similar blocks identified for the each of the smaller blocks.

### BRIEF DESCRIPTION OF THE DRAWINGS

For a better understanding of the nature and objects of the present invention, reference is made to the following detailed description taken in conjunction with the following drawings, in which:

FIGS. 1a-1d are schematic representations illustrating using variable size image blocks comprising multiple pixels, according to an embodiment of the present invention: FIG. 1a corresponds to a portion of an image frame to be restored comprising 32×32 pixels with block sizes of 8×8, 4×4 and 2×2 pixels successively shown in FIGS. 1b, 1c and 1d, respectively;

FIG. 2 is a schematic representation illustrating identifying similar blocks within a searching area in a reference image frame and other image frames of the same scene using outer blocks, according to an embodiment of the present invention;

FIG. 3 is a block diagram of an electronic device adapted for image restoration, according to an embodiment of the present invention; and

FIG. 4 is a flow chart demonstrating image restoration, according to an embodiment of the present invention.

### MODES FOR CARRYING OUT THE INVENTION

A new method, apparatus and software product are presented for restoring (i.e., de-noising and/or stabilizing) images using similar blocks of pixels of one or more different sizes in one or more available image frames of the same scene for providing, e.g., multi-frame image restoration/de-noising/stabilization. According to an embodiment of the present invention, one or more similar blocks of a block (which can be called a reference block, a reference image block or an image block) comprising a plurality of pixels and comprised in a reference frame (i.e., one frame selected from one or more available image frames of a scene automatically by the electronic device or through a user interface of the electronic device) can be identified in the one or more image frames using a predetermined criterion as described herein, e.g., by an electronic device (apparatus). Then restoring (or fusing) of this reference block can be performed, e.g., by the electronic device by combining, using a predetermined algorithm as described herein, pixel signals of the plurality of the pixels comprised in the reference block with corresponding pixel signals of the one or more similar blocks identified for this reference block.

According to a further embodiment of the present invention, the reference block can be restored using the predetermined algorithm if enough of the one or more similar blocks is found according to the predetermined criterion, and if there is not enough of the one or more similar blocks is found, this reference block can be further divided into smaller blocks each comprising one or more pixels. Then the procedure is similar to the identifying and restoring the original (parent) reference block before the division, i.e., identifying one or more further similar blocks for each of the smaller (divided) blocks using said predetermined criterion or another predetermined criterion (as described herein), and restoring these smaller blocks using this predetermined algorithm or the further predetermined algorithm by combining, for each of the smaller blocks, pixel signals of the one or more pixels comprised in each of the smaller blocks with corresponding pixel signals of the one or more further similar blocks identified for this each of the smaller blocks. This process of identifying of one or more similar blocks for each reference block in the reference image frame, restoring, and dividing into smaller blocks, as described herein, can continue until all the blocks (original and divided if necessary) comprised in the reference image frame are restored.

According to another embodiment, the one or more similar blocks of the reference block can be identified within a search area in the one or more image frames and the one or more further similar blocks of the smaller blocks (comprised in the original reference block) can be identified within the search area or within a further search area (this further search area can be for instance smaller than the search area for the original reference block) in the one or more image frames.

According to one embodiment of the present invention, identifying of the one or more similar blocks can be performed by comparing pixel signals of the plurality of pixels comprised in the reference block with corresponding pixel signals of other blocks of the one of more image frames within the search area against one or more predetermined threshold values (or threshold conditions in general), as described herein. The same is applied to the smaller blocks after dividing the reference block into these smaller blocks. Moreover, this identifying of the one or more similar blocks can be performed by comparing pixel signals of the plurality of pixels comprised in an outer block centered in and comprising this reference block with corresponding pixel signals of other outer blocks centered in and comprising corresponding other blocks of the one or more frames within the search area against one or more further threshold conditions (or further threshold conditions in general). The same is applied to the smaller blocks after dividing the reference block into these smaller blocks. The size of the outer blocks for the smaller blocks can have a pre-selected size but may be modified (or stay the same) for the smaller blocks after dividing the reference block into these smaller blocks. Similarly the threshold conditions for the original (parent) reference blocks can be the same or can be different than the further threshold conditions for the smaller (divided) blocks.

The electronic device (apparatus) which may be performing the functions of identifying similar blocks and restoring reference block with possible division into smaller blocks can be also configured to capture the one or more frames of the scene. Alternatively, the one or more frames of the scene can be provided to the electronic device through a network communication, e.g., over the Internet. The electronic device can be (but is not limited to) a digital camera, a communication device, a wireless communication device, a portable electronic device, a mobile electronic device, a camera phone, etc.

According to a further embodiment of the present invention, the identifying and restoring of the reference blocks can be performed independently for one or more color components comprised in the one or more image frames. For example, the one or more similar blocks for the reference block can be identified separately for one or more selected color components of the one or more color components and the restoring of the reference block may be performed only for the one or more selected color components (e.g., only for one selected color component or for all color components, etc.), as described herein. Alternatively, the restoring of the reference block may be performed in combination for all color components comprised in said one or more image frames, such that the one or more similar blocks for the reference block are identified for all color components in combination and said restoring of the reference block is performed for each of the all color components only if the one or more similar blocks are found for the all color components in combination (i.e., for all color components at the same time). But in general, one or more similar blocks identified for each block may be the same or different for each color component comprised in the one or more image frames.

Different embodiments of the present invention describe how to exploit the redundancy present in a natural image, wherein an image region (i.e., the block of pixels) is often similar (e.g., visually similar) according to the predetermined criterion to other regions or blocks of pixels in the same image and possibly in other images of the scene, if available. For example, an image block of 8×8 pixels located in a smooth image area (e.g., a sky) may be similar to several other image blocks located in the same image. Also, if the image block represents, e.g., a vertical edge between two different colors, then several similar blocks could be found along the same edge. Thus, the approach of image de-noising and/or stabilization disclosed herein is based on identifying and fusing together visually similar image blocks found in a single, or in multiple images (i.e., image frames) of the same scene.

In accordance with various embodiments of the present invention, the size of the blocks (or image blocks) can be adapted to the image content in a sense that larger image blocks can be used in smooth image areas, and smaller image blocks can be considered for improving areas that contain small details. More specifically, the procedure may start first by considering image blocks of larger sizes, which are then subdivided to smaller blocks in accordance with the image content if necessary.

Moreover, according to one embodiment, if multiple input images (or image frames) are available, one of them is selected as the reference image frame and the algorithm is then aiming to restore this image frame based on the visual information available in all input images (including the reference image frame). To do this, the reference image frame can be divided into blocks (e.g., non-overlapping blocks) which are processed individually. For each such block a decision is made whether it is possible to restore the block as such, or it is necessary to split the block further into smaller blocks. The decision to restore the block is taken when at least one or a sufficient number of visually similar blocks are found in the input image frames. In such a case the block can be restored by fusing together all similar blocks found according to the predetermined algorithm. This is most often the case in smooth image areas of the scene. On the other hand, in more detailed areas of the scene an image block may have only a small number of visually similar blocks in the input images or may do not have visually similar blocks in the input images at all. In such a case the decision is made to split the block into smaller blocks which are then independently processed in a similar manner as the parent block (i.e., either restoring or splitting further).

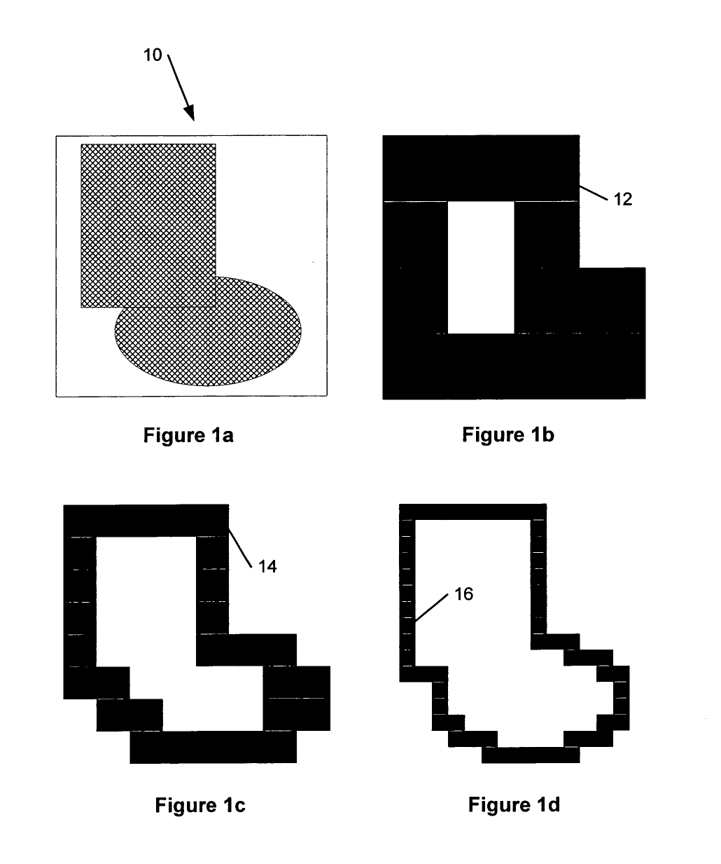

FIGS. 1a-1d shows an example among others of schematic representations illustrating using variable size image blocks comprising multiple pixels, according to an embodiment of the present invention: FIG. 1a corresponds to a portion of an image frame 10 to be restored and comprises 32×32 pixels with block sizes of 8×8, 4×4 and 2×2 pixels successively shown in FIGS. 1b, 1c and 1d, respectively. FIG. 1b shows in white the location of those 8×8 blocks that can be restored in the first step, and in black the locations of those 8×8 image blocks 12 that must be subdivided into smaller image blocks (i.e., 4×4). Next, some of these new 4×4 image blocks can be restored whereas other blocks 14, shown with black in FIG. 1c, are further subdivided into 2×2 image blocks. Finally, FIG. 1d shows in back those image regions where the 2×2 blocks 16 should be further subdivided into individual pixels for further processing and restoring.

It is further noted that the embodiments described herein can be adopted to a number of input image frames. For example if multiple image frames of the scene are available, it might be sufficient to use only one block size as long as there is an increased chance to find enough similar blocks in all input image frames. On the other hand, when the number of input image frames is small, or in cases when some of the input image frames are occluded by moving objects, the processing may require splitting the larger blocks into smaller blocks in order to restore the detailed image areas.

Also the embodiments described herein can be adopted to the way the image is going to be visualized. The subdivision of the blocks into smaller blocks may be needed for improving the visibility of small image details, however, in some cases small image details cannot be visualized, like for instance when the image is shown on a small display (e.g., a viewfinder). Consequently, in accordance with the way the image is visualized we can impose a smaller or a larger limit onto the smallest image block that should be considered. Once this smallest block size is achieved no further subdivision may be allowed, forcing the restoration of the corresponding image blocks based on the available similar blocks found.

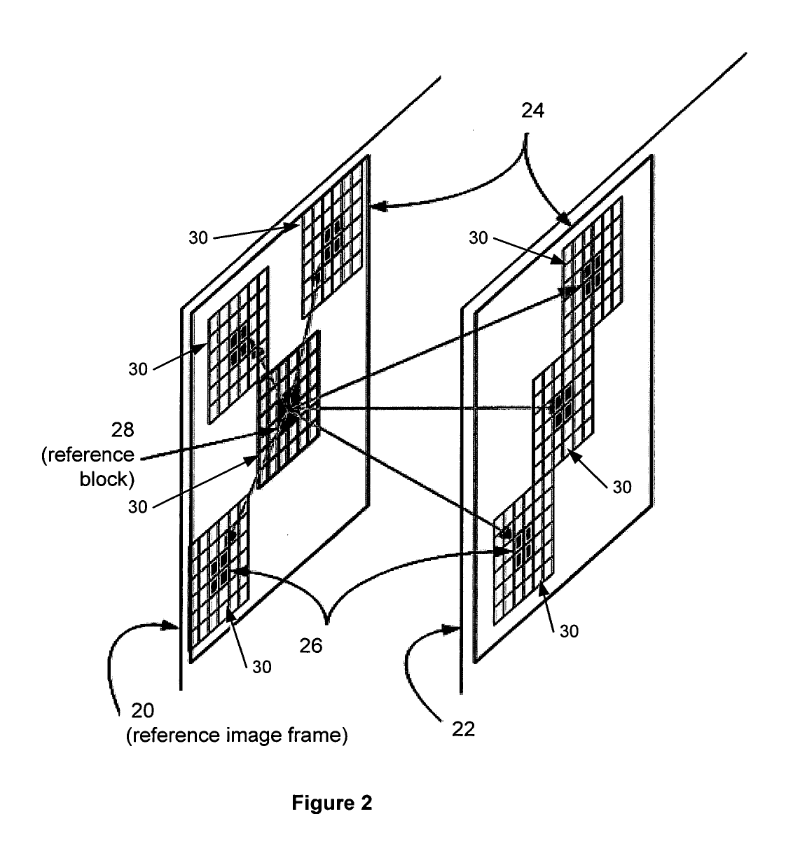

The block similarity, according to embodiments of the present invention, is discussed in more detail. FIG. 2 shows an example among others of a schematic representation illustrating identifying similar blocks 26 within a search area 24 in a reference image frame 20 and other image frames of the same scene using outer blocks 30 of the reference block 28, according to an embodiment of the present invention;

Thus, as illustrated in FIG. 2, for each block (e.g., the reference block 28) in the reference image frame 20, the algorithm can look for similar blocks in all input image frames (e.g., in an adjacent frame 22 as shown in FIG. 2), inside the search area 24. Also for each image block, e.g., blocks 26, a larger neighborhood centered in the block, called the outer-block 30, can be used for identifying the visual similarity between the reference block 28 and a blocks under evaluation by matching their outer-blocks 30, rather than the blocks themselves (the blocks themselves can be used as well for identifying similar blocks as described above). The usage of a larger neighborhood for matching than the block itself can be useful especially when dealing with very small blocks (e.g., 2×2 block of pixels or even 1 pixel in case of further dividing the 2×2 block). In such a case the pixels available in the block may be insufficient for the evaluation of the visual similarity between the two image blocks. In FIG. 2 the outer block 30 has a size of 6×6 pixels, whereas the actual image blocks are of the size 2×2 pixels. When the block size shrinks down to 1 pixel, using the “outer-block” can become necessary for similarity calculation.

In general, given two image blocks B₁ and B₂, the similarity function sim((B₁,B₂) between them can be calculated using the following algorithm. First, the outer-blocks U₁ and U₂ of the two input blocks B₁ and B₂ are identified. Then, the mean square error or some other difference function between the pixels of the two outer-blocks (e.g., between pixel signals of these two blocks) d=dif(U₁,U₂) is calculated. In case of color images, d is a vector may be of a size 3×1, that comprises the three separate difference components d(1), d(2) and d(3), e.g., for red, green and blue (RBG) pixels or other color components if used. It is also possible to have more than 3 channels like for instance in multi-spectral imaging. Another common example when the number of color channels may be larger than 3 is when the proposed algorithm could be directly applied to the RAW Bayer image data delivered by the sensor before de-mosaicing (i.e., color filter array interpolation). In such a case the number of channels is 4, i.e., Red, Blue, Green1, and Green2.

The further calculations may comprise of calculating the normalized difference D between the two blocks by taking into consideration the noise power. For gray scale images D may be given by:

D²=(d/s)² (1),

wherein s is the noise standard deviation. For color images the square normalize distance can be given by:

$${D}^{2} = {\sum }_{c = 1}^{3} {[ \frac{d ( c )}{s ( c )} ]}^{2} , \qquad ( 2 )$$

wherein d(c) and s(c) are the block difference components and the noise standard deviation for the color plane c, respectively. Then the similarity function sim(B₁,B₂) between the two blocks can be estimated using, a monotonically decreasing function between 0 and 1. For instance, such a function could be as follows:

$$w = sim ( {B}_{1} {B}_{2} ) = exp ( - \frac{{D}^{2}}{{τ}^{2}} ) , \qquad ( 3 )$$

wherein τ is a real parameter that can be used to adjust the smoothness of the result. It is noted that such similarity function has values between 0 and 1 being closer to 1 as the blocks are more similar. Finally the similarity function w calculated between the two given blocks using Equation 3 can be compared with a threshold value t to determine if the two blocks are similar. For multi-color image frames different scenarios can be used. One option is to use Equation 3 with the normalized difference function D calculated using Equation 2, i.e., for all color components in combination, such that if the similarity condition is met against the threshold value t for the D described by the Equation 2 for all color components simultaneously, then the block under consideration is considered to be a similar block to the reference block.

Alternatively, individual color component of the one or more multi-color image frames can be evaluated separately such that the normalized difference function D is calculated using Equation 1 separately for each color and the similarity function using Equation 3 with D calculated using Equation 1 can be calculated for each color separately and compared with the threshold value t separately making decision for similarity separately for each color and thus restoring each color independently. It is noted that many color spaces besides RGB can be used with the method described herein which include but are not limited to YUV (having luminance color component Y and chrominance color components U and V), HSV (hue, saturation, value), CIE-Lab (lab color space), “opponent” color spaces, etc. It is also possible to calculate the block similarity based only on a single channel, e.g., Y channel when using the YUV color space, without involving at all the other channels U and V.

The methodology for restoring images according to embodiments of the present invention can be implemented using various scenarios. One general scenario is considered herein. In this scenario the output image calculated by this algorithm is denoted by O. A set of considered image block sizes with pixel numbers is given by B₁×B₁, B₂×B₂, . . . , B_{M}×B_{M}, wherein B₁>B₂> . . . >B_{M}. It is noted that the image block size is not necessarily to be square but generally can be rectangular. For each block size Bₘ, an outer-block size Uₘ and a search area (range) Sₘ are specified.

In the following algorithm the reference blocks are stored in a so-called block queue, denoted by Q. This data structure is helpful in the sense that it simplifies the algorithm flow and improves the efficiency by simplifying the image block handling in the real implementation. A reference image block is completely defined by its position in the reference image frame and by its size. So for each block it is enough to store three integer numbers (i.e., position and size) in the queue, rather than all block pixels. Finally, it is important to mention that in the following algorithm the decision whether a block should be restored or subdivided further is taken based on a threshold value T, which can be provided as a parameter to the algorithm. Algorithm can comprise of the following steps:

1. Select a reference image frame among the available frames of the scene. The selection can be done automatically by the system based on some criteria like image sharpness. Alternatively, noting that the scene may change between the capturing moments of different image frames, the selection of the reference frame can be done by the user (e.g., through a user interface) who may chose, based on a subjective opinion, which frame of the scene captures the “right moment” he/she wanted to capture. For instance some moving objects in the scene may have very different positions in different frames or they may be absent from some frames and present in other frames. Thus, the user may select what he/she wants to have in the final picture by selecting the reference frame accordingly.
2. Divide the reference images into non-overlapping blocks (but it could be over-lapping blocks in general) of size B₁×B₁, and store all these blocks into the block queue Q (more specifically store only the position and size of each block).
3. Get from Q the position and size of the next reference block B₀. In the following we assume that the size of this block is Bₘ×Bₘ, wherein m is an integer of a value from 1 to M.
4. For each block Bₙ (n>0) of size Bₘ×Bₘ located inside the Sₘ×Sₘ spatial neighborhood (i.e., the search area) of the reference block Bₒ, either inside of the reference image or inside of other input images of the same scene calculate the similarity function wₙ=sim(Bₒ,Bₙ), e.g., using Equation 3 in accordance with the algorithm described by Equations 1-3.
5. Calculate the average weight as follows:

$$W = \frac{1}{N} {\sum }_{n = 1}^{N} {w}_{n} , \qquad ( 4 )$$

wherein N is the total number of similar blocks Bₙ found in all input images inside the search area. It is noted that the similarity function wₙ can be calculated based on all color channels or based on one or selected color channels for a multi-color space (e.g., for one luminance color component Y in the YUV color space).

It is further noted that before calculating the average weight W using Equation 4, an intermediate step could be used to compare each similarity function wₙ with the threshold t described above that is typically smaller than the threshold “T” (e.g., t can be about 8-10 times smaller). If wₙ<t then the corresponding block is not considered subsequently and not considered in Equation 4 because it is not similar with the reference block.

6. If there are enough similar blocks (i.e. W≧T) or the block B₀ cannot be subdivided (i.e. m=M), then restore the reference block. The restored value of each pixel (x,y) located inside the block B₀ of the reference frame may be calculated, e.g., as a weighted average, as follows:

$$O ( x , y ) = \frac{{B}_{0} ( x , y ) + {\sum }_{n = 1}^{N} {w}_{n} {B}_{n} ( x , y )}{1 + NW} , \qquad ( 5 )$$

wherein O(x,y) denotes the output image value at pixel (x,y), x and y being pixel coordinates.
7. If there is an insufficient number of similar blocks (i.e. W<T)) and the block B₀ can be subdivided further (i.e., m<M), then split the block B₀ in sub-blocks of size Bₘ₊₁×Bₘ₊₁ and store all these blocks in the block queue Q.
8. If Q is not empty, then go to step 3 and if Q is empty, then stop the algorithm.

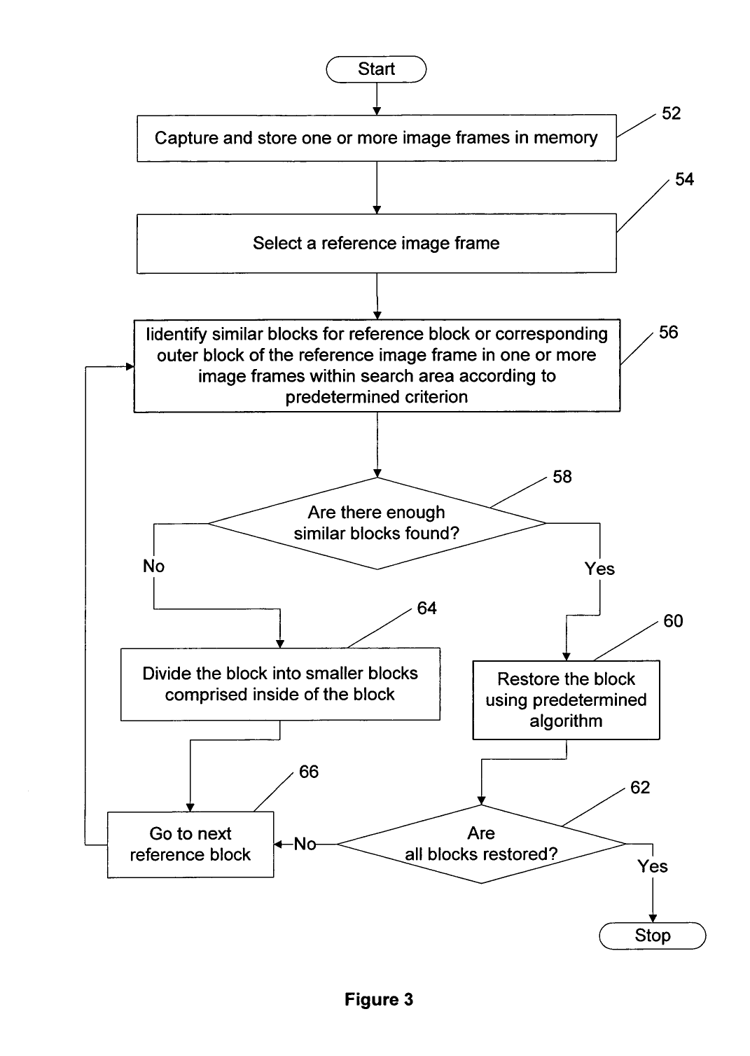

FIG. 3 shows another general example of a flow chart demonstrating image restoration, according to embodiments of the present invention.

The flow chart of FIG. 3 only represents one possible scenario among others. Detailed description of the steps depicted in FIG. 3 is provided above. It is noted that the order of steps shown in FIG. 3 is not absolutely required, so in principle, the various steps can be performed out of order. In a method according to an embodiment of the present invention, in a first step 52, one or more image frames of a scene are captured and stored in a memory. In a next step 54, a reference image is selected among one or more image frames. In a next step 56, similar blocks for the reference block or for the corresponding outer block of the reference block comprised in the reference image frame are identified in one or more image frames within a search area according to a predetermined criterion, as described herein, e.g., using Equations 1-4.

In a next step 58, it is ascertained whether there are enough similar blocks found (i.e., if there are enough of the one or more similar blocks found according to a predetermined criterion, e.g., Equation 4) to justify restoration of the reference block, e.g., by comparing the value of the average weight W (calculated using Equation 4) with the threshold T, as described herein. If that is not the case, in a next step 60, the reference block is divided into smaller blocks and then the process goes to step 62. If, however, it is ascertained that there are enough similar blocks found to justify restoration of the reference block, in step 64, the reference block is restored by combining, using a predetermined algorithm (e.g., see Equation 5) pixel signals of the plurality of pixels comprised in the reference block with corresponding pixel signals of the one or more identified similar blocks. Then in a next step 66, it is further ascertained whether all blocks of the reference frame are restored. If that is the case, the process stops. If, however, it is ascertained that not all blocks of the reference frame are restored, the process goes to step 62. In step 62, the process continues and next references block (undivided or divided) is evaluated by going to step 56, thus continuing the process until all reference blocks are restored in the reference image frame.

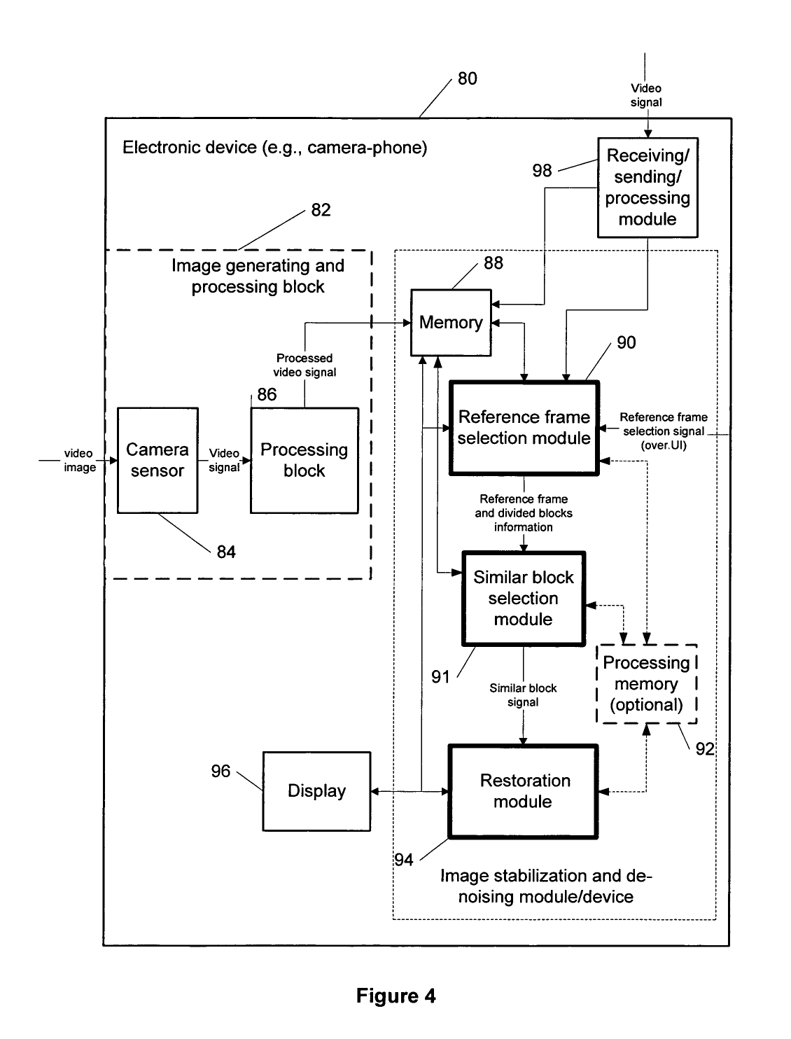

FIG. 4 shows an example among others of a block diagram of an electronic device 80 adapted for image restoration, according to an embodiment of the present invention.

FIG. 4 illustrates an example among others of a block diagram of an electronic device 80 (e.g., a camera-phone) adapted for image restoration, according to an embodiment of the present invention. The device 80 can operate on-line and off-line using images created by the image generating and processing block 82 (e.g., using a camera sensor 84 and a processing block 86), stored in a memory 88 and process them for restoring images according to various embodiments of the present invention described herein. Also the electronic device 80 can operate on-line (as well as off-line) using, e.g., the receiving/sending/processing block 98 (which typically includes transmitter, receiver, central processing unit CPU, etc.) to receive video frames externally and process them for restoring images according to various embodiments of the present invention described herein.

The image stabilization and de-noising module 93, which can be a part of the electronic device 80 or can be a separate module used independently, can comprise a reference frame selection module 90, a similar block selection module 91 and a block restoration module 94. The reference frame selection module 90 can be used for selecting a reference image frame (step 54 in FIG. 3) out of a plurality of the one or more image frames of the same scene automatically or using a command form a user through a user interface (UI). Also the module 90 can be used for dividing the reference image frame into reference image blocks which can be done automatically using a predefined starting size of the reference block.

The similar block selection module 91 is configured to identify (using e.g., the outer-blocks approach) one or more similar blocks of the reference block in one or more image input frames of a scene in a search area based on a predetermined criterion (e.g., step 56 in FIG. 3, Equations 1-4), using various embodiments of the present invention, as described herein. Moreover, the module 91 can be configured to perform step 58 of FIG. 3 for deciding if there are enough similar blocks found for the reference block according to the predetermined criterion, e.g., by comparing the value of the average weight W (calculated using Equation 4) with the threshold T, as described herein. Furthermore, the module 91 can be also configured to divide the reference block into smaller blocks (e.g., step 64 in FIG. 3) if not enough similar blocks of the reference block is found in step 58 of FIG. 3 and then perform the identifying similar blocks for the divided blocks similar to the procedure for the parent reference block, described herein.

The block restoration module 94 can be configured to restore the reference blocks by combining, using a predetermined algorithm (e.g., step 60 in FIG. 3 and Equation 5), pixel signals of the plurality of pixels comprised in the reference block with corresponding pixel signals of the one or more similar blocks identified for the reference block by the module 91. It is noted that an optional additional memory 92 can be used to facilitate processing calculations by the modules 90, 91 and 94.

According to an embodiment of the present invention, the block 90, 91 or 94 can be implemented as a software or a hardware block or a combination thereof. Furthermore, the module 90, 91, or 94 can be implemented as a separate module or can be combined with any other module of the electronic device 80 or it can be split into several modules according to their functionality.

It is noted that the frame image similar block selection module 91 generally can be means for identifying or a structural equivalence (or an equivalent structure) thereof. Also, the block restoration module 94 can generally be means for restoring or a structural equivalence (or equivalent structure) thereof. Furthermore, the reference frame selection module 90 can generally be means for selecting or a structural equivalence (or equivalent structure) thereof.

The advantages of the methodology for image restoration described herein can include but are not limited to:
1. Tolerating misalignment between the input image frames due to camera motion;
2. Ability to deal with moving objects in the scene and any scene changes during the time the input frames are acquired; if there are objects in the scene which are moving during the time the image frames are acquired, then these objects are not distorted in the final image: such objects can be preserved in one copy or remove entirely depending on the frame selected as reference;
3. Applicability to both still image and video signal enhancement and ability to adapt to the number of available frames of the same scene;
4. Easy implementation and integration in products for, e.g., both RAW domain image restoration and RGB domain image restoration;
5. Scalability: ability to easily adjust complexity/quality to the way the visual information is going to be presented (e.g. visualization on the viewfinder, on a large display, printing, etc.);
6. Ability to prevent a degradation of the output image if some of the input image frames are degraded;
7. Much lower complexity than the non-local averaging image de-nosing solution described by A. Buades, referenced herein, due to the use of image blocks, and restricted search space, etc.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is further noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
identifying one or more similar blocks of a block in one or more image frames of a scene using a predetermined criterion, wherein said block comprises a plurality of pixels and is comprised in a reference image frame, said reference image frame being one of said one or more image frames; and
restoring said block by combining, using a predetermined algorithm, pixel signals of the plurality of pixels comprised in said block with corresponding pixel signals of said one or more similar blocks identified for said block.

2. The method of claim 1, wherein said restoring is implemented only if enough of said one or more similar blocks is found according to said predetermined criterion, and if there is not enough of said one or more similar blocks found, the method further comprises:
further dividing said block into smaller blocks each comprising one or more pixels;
identifying one or more further similar blocks for each of said smaller blocks using said predetermined criterion or a further predetermined criterion; and
restoring said smaller blocks using said predetermined algorithm or a further predetermined algorithm by combining, for each of the smaller blocks, pixel signals of the one or more pixels comprised in said each of the smaller blocks with corresponding pixel signals of said one or more further similar blocks identified for said each of said smaller blocks.

3. The method of claim 2, wherein said one or more similar blocks are identified within a search area in said one or more image frames and said one or more further similar blocks are identified within said search area or within a further search area in said one or more image frames.

4. The method of claim 1, wherein before said identifying, the method comprises:
selecting said reference image frame of the scene out of the one or more image frames of said scene automatically or through a user interface.

5. The method of claim 1, further comprising:
performing said identifying and said restoring using said predetermined criterion and said predetermined algorithm for each block beside said block of a plurality of blocks in said reference image frame.

6. The method of claim 1, wherein said identifying of the one or more similar blocks is performed by comparing pixel signals of the plurality of pixels comprised in an outer block centered in and comprising said block with corresponding pixel signals of other outer blocks centered in and comprising corresponding other blocks of said one of more image frames within a search area using one or more threshold values.

7. The method of claim 1, wherein said identifying and said restoring is performed independently for one or more color components comprised in said one or more image frames.

8. The method of claim 7, wherein said one or more similar blocks for said block are identified separately for one or more selected color components of said one or more color components and said restoring is performed only for said one or more selected color components.

9. The method of claim 1, wherein said identifying and said restoring is performed in combination for all color components comprised in said one or more image frames, such that said one or more similar blocks for said block are identified using said predetermined criterion for said all color components and said restoring of said block is performed for each of said all color components only if said one or more similar blocks are found for all said color components in combination.

10. The method of claim 1, wherein said identifying and said restoring is performed by an electronic device which is a digital camera, a communication device, a wireless communication device, a portable electronic device, a mobile electronic device or a camera phone.

11. A computer program product comprising: a computer readable storage structure embodying a computer program code thereon for execution by a computer processor with said computer program code, wherein said computer program code comprises instructions for performing the method of claim 1.

12. An apparatus, comprising:
a similar block selection module, configured to identify one or more similar blocks of a block in one or more image frames of a scene using a predetermined criterion, wherein said block comprises a plurality of pixels and is comprised in a reference image frame, said reference image frame being one of said one or more image frames; and
a block restoration module, configured to restore said block by combining, using a predetermined algorithm, pixel signals of the plurality of pixels comprised in said block with corresponding pixel signals of said one or more similar blocks identified for said block.

13. The apparatus of claim 12, wherein said similar block selection module is configured to divide said block into smaller blocks each comprising one or more pixels, if not enough of said one or more similar blocks is found according to said predetermined criterion, to further identify one or more further similar blocks for each of said smaller blocks using said predetermined criterion or a further predetermined criterion, and said restoration module is further configured to restore said smaller blocks using said predetermined algorithm or a further predetermined algorithm by combining for each of the smaller blocks pixel signals of the one or more pixels comprised in said each of the smaller blocks with corresponding pixel signals of said one or more further similar blocks identified for said each of said smaller blocks.

14. The apparatus of claim 13, wherein the similar block selection module is configured to identify said one or more similar blocks within a search area in said one or more image frames, and the similar block selection module is configured to identify said one or more further similar blocks within said search area or within a further search area in said one or more image frames.

15. The apparatus of claim 13, wherein one or more threshold conditions for identifying said one or more similar blocks of said block and for identifying said one or more further similar blocks of said smaller blocks are the same or different.

16. The apparatus of claim 12, wherein said one or more image frames is provided to said apparatus through a network communication.

17. The apparatus of claim 16, wherein said network communication is a network communication over Internet.

18. The apparatus of claim 12, further comprising:
a reference frame selection module, configured to select said reference image frame of the scene out of the one or more image frames of said scene automatically or using a command provided through a user interface.

19. The apparatus of claim 12, wherein the similar block selection module is configured to identify said one or more similar blocks within a search area in said one or more image frames.

20. The apparatus of claim 12, wherein said similar block selection module is configured to identify said one or more similar blocks by comparing pixel signals of the plurality of pixels comprised in said block with corresponding pixel signals of other blocks in said one or more images within a search area using one or more threshold values.

21. The apparatus of claim 12, wherein the similar block selection module is configured to identify said one or more similar blocks by comparing pixel signals of the plurality of pixels comprised in an outer block centered in and comprising said block with corresponding pixel signals of other outer blocks centered in and comprising corresponding other blocks of said one of more image frames within a search area using one or more threshold values.

22. The apparatus of claim 12, wherein the similar block selection module is configured to identify the one or more similar blocks and the block restoration module is configured to restore said block independently for one or more color components comprised in said one or more image frames.

23. The apparatus of claim 12, wherein the similar block selection module is configured to identify said one or more similar blocks for said block separately for one or more selected color components of said one or more color components such that the block restoration module is configured to restore said only for said one or more selected color components.

24. The apparatus of claim 12, wherein the similar block selection module is configured to identify the one or more similar blocks and the block restoration module is configured to restore said block in combination for all color components comprised in said one or more image frames, such that said one or more similar blocks for said block are identified using said predetermined criterion for said all color components and said restoring of said block is performed for each of said all color components only if said one or more similar blocks are found for all said color components in combination.

25. An electronic device, comprising:
image capturing module, for capturing one or more image frames;
a similar block selection module, configured to identify one or more similar blocks of a block in one or more image frames of a scene using a predetermined criterion, wherein said block comprises a plurality of pixels and is comprised in a reference image frame, said reference image frame being one of said one or more image frames; and
a block restoration module, configured to restore said block by combining, using a predetermined algorithm, pixel signals of the plurality of pixels comprised in said block with corresponding pixel signals of said one or more similar blocks identified for said block.

26. The electronic device of claim 25, further comprising:
a memory for storing said one or more image frames.

27. An apparatus, comprising:
means for identifying one or more similar blocks of a block in one or more image frames of a scene using a predetermined criterion, wherein said block comprises a plurality of pixels and is comprised in a reference image frame, said reference image frame being one of said one or more image frames; and
means for restoring said block by combining, using a predetermined algorithm, pixel signals of the plurality of pixels comprised in said block with corresponding pixel signals of said one or more similar blocks identified for said block.

28. The apparatus of claim 27, wherein said means for identifying is configured to divide said block into smaller blocks each comprising one or more pixels if said one or more similar block are not found and to identify one or more further similar blocks for each of said smaller blocks using said predetermined criterion or a further predetermined criterion, and said means for restoring is configured to restore said smaller blocks using said predetermined algorithm or a further predetermined algorithm by combining for each of the smaller blocks pixel signals of the one or more pixels comprised in said each of the smaller blocks with corresponding pixel signals of said one or more further similar blocks identified for said each of said smaller blocks.
